(19) United States
(12) Patent Application Publication
(10) Pub. No.: US 2020/0096441 A1
(43) Pub. Date: Mar. 26, 2020

(54) Optical Detecting Apparatus

(71) Applicants: Sintai Optical (Shenzhen) Co., Ltd., Shenzhen City (CN); Asia Optical Co., Inc., Taichung (TW)

(72) Inventors: Te-Wei Liu, Taichung (TW); Hiroaki Tobitsuka, Taichung (TW)

(21) Appl. No.: 16/576,934

(22) Filed: Sep. 20, 2019

(30) Foreign Application Priority Data
Sep. 20, 2018 (TW) 107133171

(51) Int. Cl. G01N 21/31

(52) U.S. Cl. CPC G01N 21/31; G01N 2201/068

(57) ABSTRACT

An optical detecting apparatus includes a light source, a receiving unit and a first optical element. The light source is configured to emit first light. The receiving unit includes a light splitting portion and a sensing portion, wherein the light splitting portion is configured to separate second light with a predetermined bandwidth from the first light, the sensing portion is configured to receive the second light with the predetermined bandwidth, and the light splitting portion and the sensing portion are connected. The first optical element is disposed between the light source and the receiving unit and is configured to converge or collimate the first light.

### BACKGROUND OF THE INVENTION

### Field of the Invention

The invention relates to an optical detecting apparatus, and more particularly to an optical detecting apparatus with high detection reliability.

### Description of the Related Art

Referring to FIG. 1, FIG. 1 depicts an optical path in a prior optical detecting apparatus 1. During operation of the optical detecting apparatus 1, a light source 2 emits light, and the light is converged by a first lens 3 and passes through an incident slit 4 to become parallel light. The parallel light enters a light splitter 5, and the light splitter 5 spreads the parallel light into a continuous spectrum according to the wavelengths thereof. The light splitter 5 is rotated, so that light with a predetermined bandwidth contained in the continuous spectrum can exactly reach an exit slit 6. The exit slit 6 allows the light with the predetermined bandwidth to pass through. Then, the light with the predetermined bandwidth passes through an object 7, is converged by a second lens 8 and enters a sensor 9 for obtaining a mittance of the light with the predetermined bandwidth. It is worth noting that light with different bandwidth can be obtained by rotating the light splitter 5, and amount of a target component contained in the object 7 can be detected by analyzing spectrum transmittance. The light splitter 5 can be substituted with an optical grating.

In the structure described above, a motor (not shown) is usually used for rotating the light splitter 5 to obtain the light with different bandwidth. However, since the motor may vibrate during operation, the light passing through the exit slit 6 may has other undesired bandwidth which is outside the predetermined bandwidth (that is, error is occurred). In addition, vibration of the light splitter 5 may change the optical path along which the light passes through the exit slit 6, the object 7 and the sensor 9, so that energy of the light received by the sensor 9 is unstable. In brief, if the vibrations of the light splitter 5 cannot be well controlled, then the detection of the prior optical detecting apparatus will be not reliable.

In an example of examining urine of a person for screening diabetes, the object 7 is urine. If the bandwidth or energy of the light is not properly controlled, the target component (such as glucose, urinary protein and ketone body) contained in urine cannot be accurately detected.

### BRIEF SUMMARY OF THE INVENTION

The invention provides an optical detecting apparatus includes an adjustable light filter produced by using MEMS (Microelectromechanial Systems) processing techniques. The adjustable light filter is packaged to be a receiving unit, and the receiving unit can substitute for conventional light splitter (or optical grating), slit and sensor. By such arrangement, the detection reliability of the optical detecting apparatus is increased as well as the structure of the optical detecting apparatus is simplified. The adjustable light filter can be substituted with a light splitter.

The optical detecting apparatus in accordance with an embodiment of the invention includes a light source, a receiving unit and a first optical element. The light source is configured to emit first light. The receiving unit includes a light splitting portion and a sensing portion, wherein the light splitting portion is configured to separate second light with a predetermined bandwidth from the first light, the sensing portion is configured to receive the second light with the predetermined bandwidth, and the light splitting portion and the sensing portion are connected. The first optical element is disposed between the light source and the receiving unit and is configured to converge or collimate the first light.

In another embodiment, the light splitting portion is a Fabry-Perot interferometer produced by using MEMS (Microelectromechanial Systems) processing techniques. The light splitting portion and the sensing portion are connected to form a single element.

In yet another embodiment, the first optical element is disposed between an object and the receiving unit, the first light enters the object, part of the first light is absorbed by the object, and the other part of the first light leaves the object, is converged or collimated by the first optical element and arrives at the receiving unit.

In another embodiment, a ratio of a first distance from the light source to the first optical element to a second distance from the first optical element to the receiving unit ranges from 1 to 5.

In yet another embodiment, the optical detecting apparatus further includes a second optical element disposed between the light source and the object to converge or collimate the first light before the first light enters the object, and a ratio of a third distance from the light source to the second optical element to a second distance from the first optical element to the receiving unit ranges from 0.1 to 10.

In another embodiment, the second optical element is a lens or concave mirror.

In yet another embodiment, the first optical element is a lens or concave mirror.

In another embodiment, the optical detecting apparatus further includes an aperture disposed between the second optical element and the object, wherein size of the aperture is tunable or fixed, and an incident angle at which the first light is incident on the aperture ranges from 1 to 30 degrees.

In yet another embodiment, the optical detecting apparatus further includes an aperture disposed between the first optical element and the receiving unit or disposed on a surface of the receiving unit.

In another embodiment, the optical detecting apparatus further includes an aperture disposed between the object and the first optical element.

In yet another embodiment, size of the aperture is tunable or fixed, and an incident angle at which the first light is incident on the aperture ranges from 1 to 30 degrees.

In another embodiment, the optical detecting apparatus further includes an aperture disposed between the first optical element and the receiving unit or disposed on a surface of the receiving unit.

In yet another embodiment, the first optical element is disposed between the light source and an object; the first light is converged or collimated by the first optical element and enters the object; part of the first light is absorbed by the object; and the other part of the first light leaves the object and arrives at the receiving unit.

In another embodiment, a ratio of a first distance from the light source to the first optical element to a second distance from the first optical element to the receiving unit ranges from 0.2 to 5.

In yet another embodiment, the optical detecting apparatus further includes an aperture disposed between the object and the first optical element, wherein size of the aperture is tunable or fixed.

In another embodiment, the light splitting portion is an adjustable light filter or light splitter.

In yet another embodiment, an aperture disposed between the light source and the receiving unit or disposed on a surface of the receiving unit.

In another embodiment, an incident angle at which the first light is incident on the aperture ranges from 1 to 30 degrees.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an optical path of a prior optical detecting apparatus;

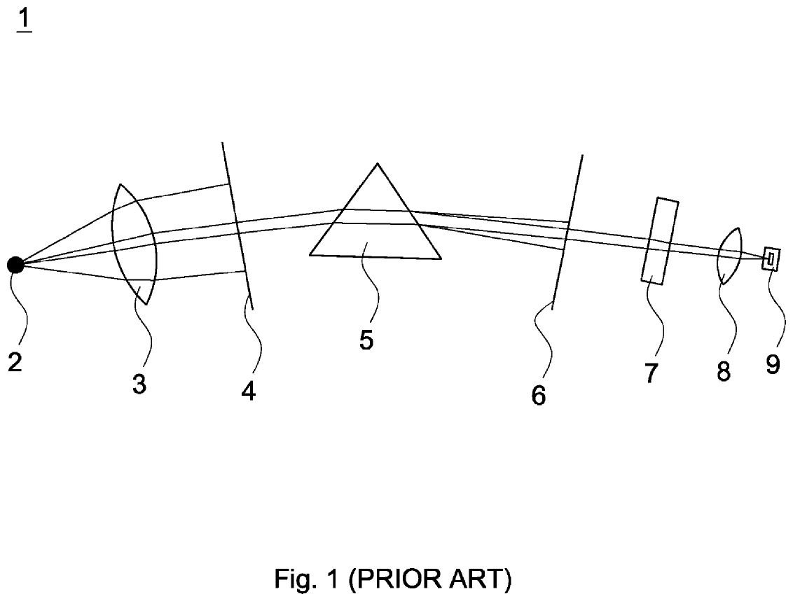

FIG. 2 is a schematic view of an optical detecting apparatus in accordance with a first embodiment of the invention;

FIG. 3 is a block diagram of a receiving unit of FIG. 2;

FIG. 4 is a schematic view of an optical detecting apparatus in accordance with a second embodiment of the invention;

FIG. 5 is a schematic view of an optical detecting apparatus in accordance with a third embodiment of the invention;

FIG. 6 is a schematic view of an optical detecting apparatus in accordance with a fifth embodiment of the invention;

FIG. 7 is a schematic view of an optical detecting apparatus in accordance with a sixth embodiment of the invention;

FIG. 8 is a schematic view of an optical detecting apparatus in accordance with a ninth embodiment of the invention;

FIG. 9 is a graph of the transmittance spectrum with three different incident angles denoted by three different types of line.

### DETAILED DESCRIPTION OF THE INVENTION

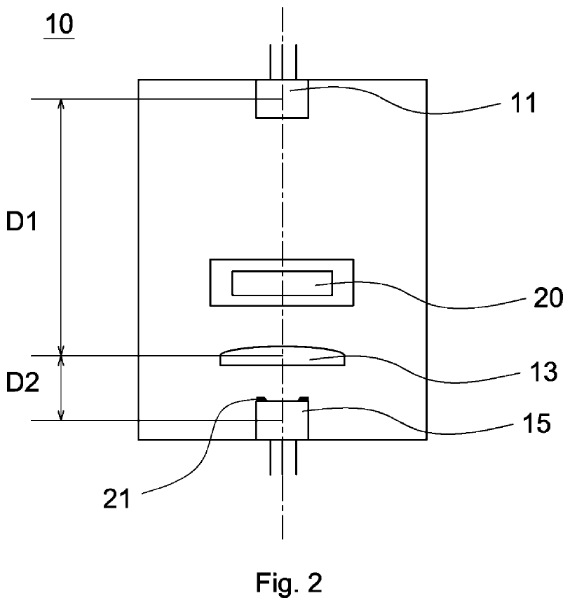

Referring to FIG. 2, an optical detecting apparatus 10 in accordance with a first embodiment of the invention includes a light source 11, a first optical element 13 and a receiving unit 15, wherein the optical detecting apparatus 10 is configured to detect amount of a target component contained in an object 20.

In the first embodiment, the light source 11 is an LED (light-emitting diode) and is configured to emit first light (not shown). The first optical element 13 is disposed between the light source 11 and the receiving unit 15 for converting the first light from divergent into converged or collimated. The first optical element 13 can be a biconvex lens, plano-convex lens or meniscus lens. In other words, the shape of the first optical element 13 is not limited to what is shown in the accompanying drawings. The first optical element 13 may be any devices capable of converging or collimating light.

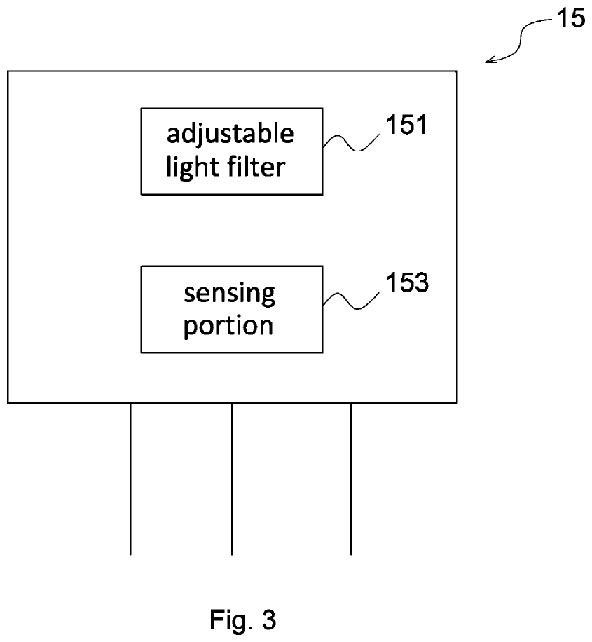

The receiving unit 15 includes a light splitting portion and a sensing portion 153, wherein the light splitting portion may be an adjustable light filter 151 as shown in FIG. 3. In the first embodiment, the adjustable light filter 151 is a Fabry-Perot interferometer (FPI) produced by using MEMS (Microelectromechanial Systems) processing techniques and is configured to separate second light with a predetermined bandwidth from the first light. The sensing portion 153 is an InGaAs photodiode. It is worth noting that the adjustable light filter 151 is much smaller than the conventional light splitter in volume due to MEMS processing techniques. In addition, the adjustable light filter 151 and the sensing portion 153 are connected to form a single micro-element, so that the optical detecting apparatus 10 with the receiving unit 15 is simplified in structure, microminiaturized and portable. Specifically, the adjustable light filter 151 and the sensing portion 153 are compacted or packaged to form the single micro-element. In another embodiment, the adjustable light filter 151 is substituted with a light splitter.

As shown in FIG. 2, in the first embodiment, the optimum light gathering efficiency equals a ratio of a first distance D1 from the light source 11 to the first optical element 13 to a second distance D2 from the first optical element 13 to the receiving unit 15, and also equals a ratio of a diameter of the light source 11 to a diameter of the sensing portion 153. Considering area of commercial light source and area of commercial sensing portion, the ratio of the first distance D1 to the second distance D2 ranges from 1 to 5 for optimizing the light gathering efficiency. Preferably, the ratio of the first distance D1 from the light source 11 to the first optical element 13 to the second distance D2 from the first optical element 13 to the receiving unit 15 is substantially 2.

During operation, the first light emitted by the light source 11 enters the object 20. The object 20 absorbs part of the first light and allows the other part of the first light to leave. The part of the first light leaving the object 20 enters the first optical element 13, is converged or collimated by the first optical element 13 and is directed to the receiving unit 15. The first light emitted by the light source 11 has a plurality of bandwidths, the adjustable light filter 151 separates second light with a predetermined bandwidth from the first light, and the second light with the predetermined bandwidth is received by the sensing portion 153. After repeated separation, different bandwidths of second light are separated out by the adjustable light filter 151 and received by the sensing portion 153. When the first light passes through the object 20, the target component contained in the object 20 is able to absorb different amounts of optical energy from different bandwidths of first light. Therefore, the amount of the target component contained in the object 20 can be found out by analyzing spectrum transmittance.

Since MEMS processing techniques are applied to production of the receiving unit 15, the optical path in the optical detecting apparatus 10 is simpler than the conventional optical path that can effectively reduce the errors generated during operation of the optical detecting apparatus 10. In addition, the first optical element 13 is placed between the object 20 and the receiving unit 15 to converge or collimate the first light before the first light enters the receiving unit 15, so that the energy of the first light becomes more concentrated as well as the strength of the second light received by the sensing portion 153 is enhanced. When the first optical element 13 is placed between the object 20 and the receiving unit 15, the quantity of light that is received by the receiving unit 15 is maximal, the structure of the optical detecting apparatus 10 is most compact, and it is advantageous to pick and place the object 20. In brief, the detection reliability of the optical detecting apparatus 10 is increased by use of concentrated energy and accurate MEMS operation.

An example of operating the optical detecting apparatus 10 to detect amount of a target component (e.g. glucose, urinary protein, ketone body) contained in urine is described below. When the first light emitted by the light source 11 enters the urine, the target component contained in the urine absorbs energy from each bandwidth of the first light, so that the energy of each bandwidth of the first light is decreased in varying degrees. The energy of a predetermined bandwidth of the first light is greatly decreased by the target component, while the energy of other bandwidths of the first light is less decreased by the target component. The receiving unit 15 receives the first light passing through the urine and the first optical element 13. Then, the amount of the target component contained in the urine can be obtained by analyzing spectrum transmittance. If the target component is glucose, the predetermined bandwidth ranges from 1600 to 1800 nm. If the target component is urinary protein, the predetermined bandwidth ranges from 2100 to 2350 nm. Ketone body includes ethyl acetate, β-hydroxybutyrate and acetone. When the amount of the target component contained in the urine of the person is too high, it is predicted that the person may have diabetes. In another embodiment, the light source 11 is provided with a reflector (not shown). In such arrangement, the signal-to-noise ratio (S/N) can be improved, the directivity angle can be reduced, and the light quantity loss can be suppressed.

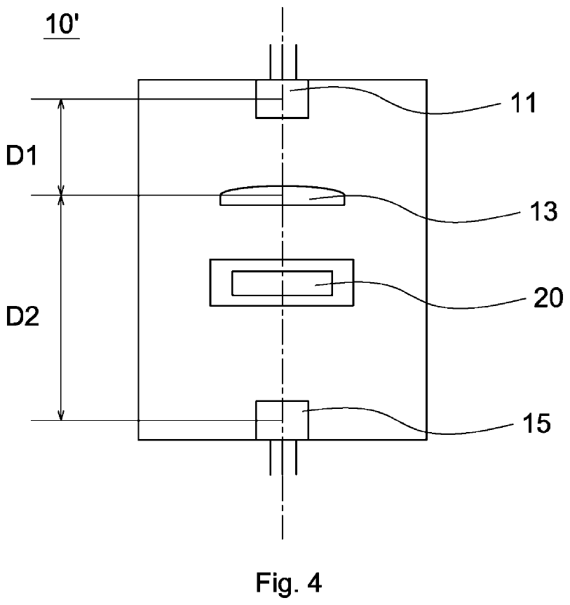

Referring to FIG. 4, an optical detecting apparatus 10′ in accordance with a second embodiment of the invention includes a light source 11, a first optical element 13 and a receiving unit 15. The difference between the first and the second embodiment is that the first optical element 13 is disposed between the light source 11 and an object 20. When the first optical element 13 is placed between the light source 11 and the object 20, light is converged or collimated before entering a container (not shown) for accommodating the object 20. Therefore, the size of the container can be decreased so that the volume of the optical detecting apparatus can be further decreased. Also, the first optical element 13 placed between the light source 11 and the object 20 can compensate the disadvantage of lack of optical element between the object 20 and the receiving unit 15. The optimum light gathering efficiency equals a ratio of a first distance D1 from the light source 11 to the first optical element 13 to a second distance D2 from the first optical element 13 to the receiving unit 15, and also equals a ratio of a diameter of the light source 11 to a diameter of the sensing portion 153. Considering area of commercial light source and area of commercial sensing portion, the ratio of the first distance D1 to the second distance D2 ranges from 0.2 to 5 for optimizing the light gathering efficiency. Furthermore, the ratio of the first distance D1 from the light source 11 to the first optical element 13 to the second distance D2 from the first optical element 13 to the receiving unit 15 is substantially 4/3, 1/5 or 1/2. During operation, first light (not shown) emitted by the light source 11 is converged or collimated by the first optical element 13 and enters the object 20. Then, the object 20 absorbs part of the first light and allows the other part of the first light to pass through, so that the other part of the first light is received by the receiving unit 15. The arrangement of other elements and operation of the second embodiment are similar to those of the first embodiment described above, and therefore the descriptions thereof are omitted.

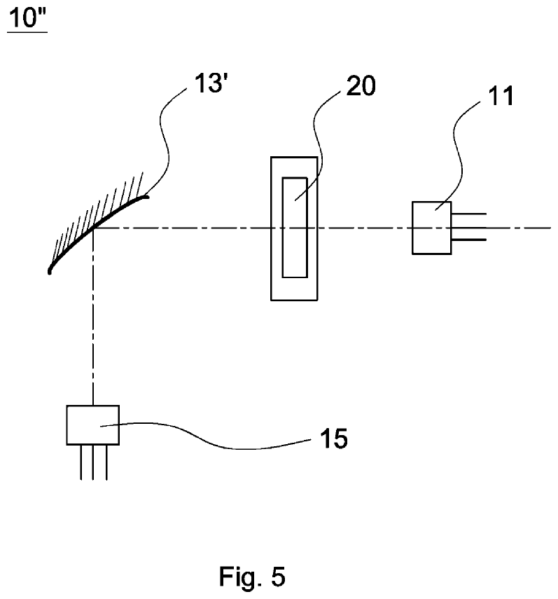

Referring to FIG. 5, an optical detecting apparatus 10″ in accordance with a third embodiment of the invention includes a light source 11, a first optical element 13′ and a receiving unit 15. The difference between the first and the third embodiment is that the first optical element 13′ is a concave mirror. During operation, first light (not shown) emitted by the light source 11 enters the object 20. The object 20 absorbs part of the first light and allows the other part of the first light to pass through. The other part of the first light is then reflected by the first optical element 13′ for being converted into converged light and is received by the receiving unit 15. The arrangement of other elements and operation of the third embodiment are similar to those of the first embodiment described above, and therefore the descriptions thereof are omitted.

In a fourth embodiment, the first optical element 13′ is disposed between the light source 11 and the object 20. In other words, first light (not shown) emitted by the light source 11 is reflected by the first optical element 13′ for being converted into converged light and enters the object 20. Then, the object 20 absorbs part of the first light and allows the other part of the first light to pass through, so that the other part of the first light is received by the receiving unit 15. The difference between the second and the fourth embodiment is that the first optical element 13′ is a concave mirror. The arrangement of other elements and operation of the fourth embodiment are similar to those of the second or the third embodiment described above, and therefore the descriptions thereof are omitted.

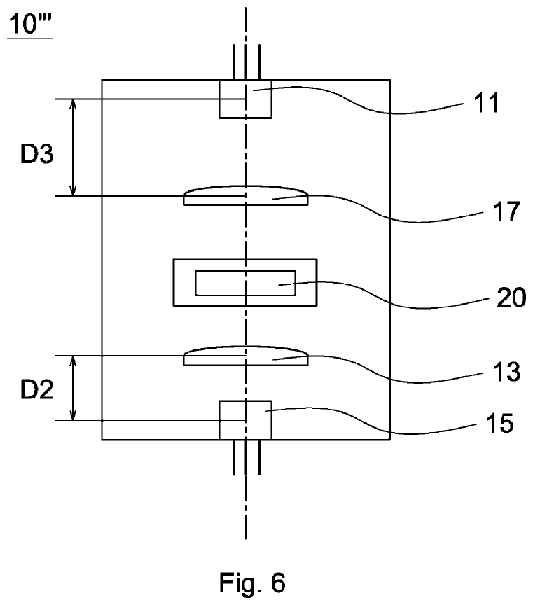

Referring to FIG. 6, an optical detecting apparatus 10′″ in accordance with a fifth embodiment of the invention includes a light source 11, a first optical element 13, a second optical element 17 and a receiving unit 15. The difference between the first and the fifth embodiment is that the second optical element 17 is further disposed between the light source 11 and an object 20, and the second optical element 17 is a biconvex lens, plano-convex lens or meniscus lens. When the optical detecting apparatus is provided with the first optical element 13 and the second optical element 17, the arrangement of elements of the optical detecting apparatus is eased. By doing so, the object 20 can be slightly tilted, the distance between the first optical element 13 and the second optical element 17 can be easily determined, and the thickness of wall of a container (not shown) for accommodating the object 20 can be easily determined. Also, since light is converged or collimated before entering the container, the size of the container can be decreased so that the volume of the optical detecting apparatus can be further decreased. During operation, first light (not shown) emitted by the light source 11 is converted into converged or collimated light by the second optical element 17 and enters the object 20. The object 20 absorbs part of the first light and allows the other part of the first light to pass through. The other part of the first light is then converted into converged or collimated light by the first optical element 13 and is received by the receiving unit 15. As shown in FIG. 6, the optimum light gathering efficiency equals a ratio of a third distance D3 from the light source 11 to the second optical element 17 to a second distance D2 from the first optical element 13 to the receiving unit 15, and also equals a ratio of a diameter of the light source 11 to a diameter of the sensing portion 153. Considering area of commercial light source and area of commercial sensing portion, the ratio of the third distance D3 to the second distance D2 ranges from 0.1 to 10 for optimizing the light gathering efficiency. The arrangement of other elements and operation of the fifth embodiment are similar to those of the first embodiment described above, and therefore the descriptions thereof are omitted.

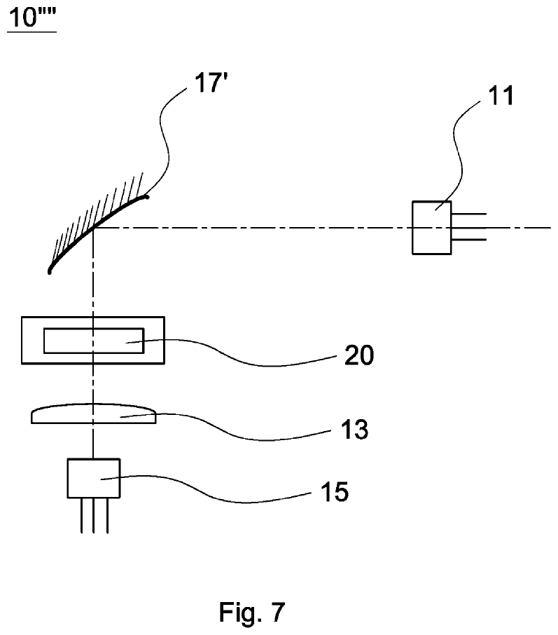

Referring to FIG. 7, an optical detecting apparatus 10″″ in accordance with a sixth embodiment of the invention includes a light source 11, a first optical element 13, a second optical element 17′ and a receiving unit 15. The difference between the sixth and the fifth embodiment is that the second optical element 17′ is a concave mirror. During operation, first light (not shown) emitted by the light source 11 is reflected by the second optical element 17′ for being converted into converged light and enters the object 20. The object 20 absorbs part of the first light and allows the other part of the first light to pass through. The other part of the first light is then converted into converged or collimated light by the first optical element 13 and is received by the receiving unit 15. The arrangement of other elements and operation of the sixth embodiment are similar to those of the fifth embodiment described above, and therefore the descriptions thereof are omitted.

In a seventh embodiment, a first optical element (not shown) is a concave mirror, and a second optical element (not shown) is a biconvex lens, plano-convex lens or meniscus lens. In other words, first light (not shown) emitted by a light source (not shown) is converted into converged or collimated light by the second optical element and enters an object (not shown). The object absorbs part of the first light and allows the other part of the first light to pass through. The other part of the first light is then reflected by the first optical element for being converted into converged light and is received by a receiving unit (not shown). The arrangement of other elements and operation of the seventh embodiment are similar to those of the fifth embodiment described above, and therefore the descriptions thereof are omitted.

In an eighth embodiment, a first optical element (not shown) is a concave mirror, and a second optical element (not shown) is also a concave mirror. In other words, first light (not shown) emitted by a light source (not shown) is reflected by the second optical element for being converted into converged light and enters an object (not shown). The object absorbs part of the first light and allows the other part of the first light to pass through. The other part of the first light is then reflected by the first optical element for being converted into converged light and is received by a receiving unit (not shown). The arrangement of other elements and operation of the eighth embodiment are similar to those of the fifth embodiment described above, and therefore the descriptions thereof are omitted.

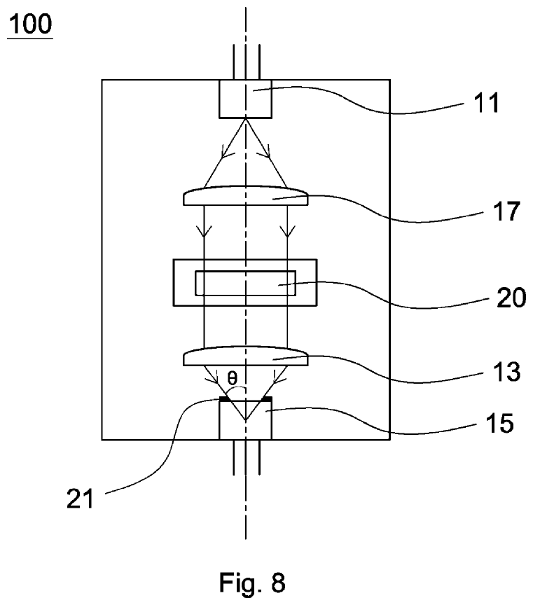

Referring to FIG. 8, FIG. 8 depicts an optical detecting apparatus 100 of a ninth embodiment of the invention, and the optical detecting apparatus 100 is amended from the optical detecting apparatus 10 of FIG. 2. The optical detecting apparatus 100 in accordance with the ninth embodiment of the invention includes a light source 11, a first optical element 13, a second optical element 17, a receiving unit 15 and an aperture 21. The aperture 21 is configured to adjust quantity of light that is allowed through the aperture 21 and is disposed on a surface of the receiving unit 15. During operation, first light (not shown) emitted by the light source 11 is converted into converged or collimated light by the second optical element 17 and enters the object 20. The object 20 absorbs part of the first light and allows the other part of the first light to pass through. The other part of the first light is then converted into converged or collimated light by the first optical element 13, is adjusted in quantity by passing through the aperture 21 and is received by the receiving unit 15. The arrangement of other elements and operation of the ninth embodiment are similar to those of the fifth embodiment described above, and therefore the descriptions thereof are omitted.

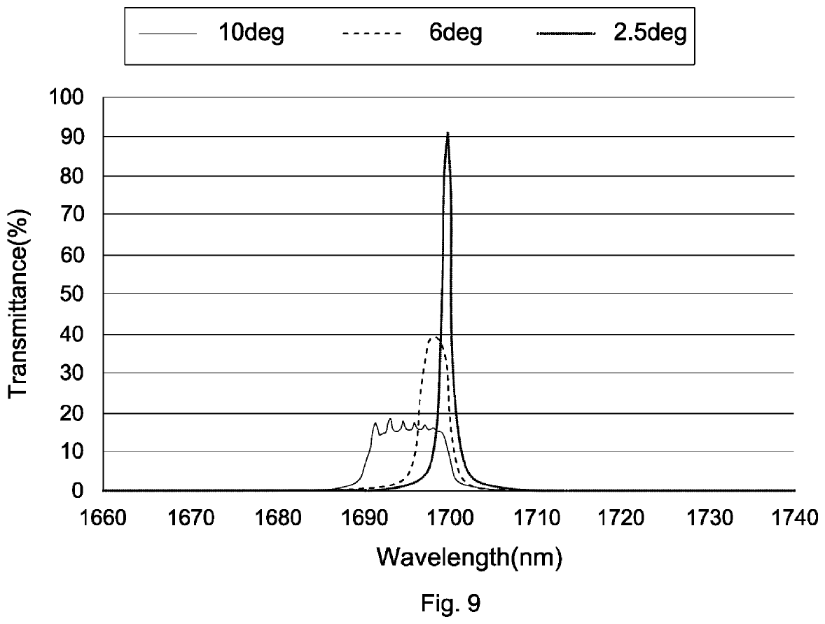

In the ninth embodiment, it is worth noting that size of the aperture 21 is tunable, so that the quantity of light that is allowed through the aperture 21 can be determined by the size of the aperture 21. The bigger the size of the aperture 21, the greater energy of light that is received by the receiving unit 15. The smaller the size of the aperture 21, the less energy of light that is received by the receiving unit 15. As shown in FIG. 8, the other part of the first light passing through the first optical element 13 is incident on the aperture 21 at an incident angle θ. As the size of the aperture 21 is tunable, the incident angle θ also can be determined by the size of the aperture 21. The bigger the size of the aperture 21, the bigger the incident angle θ. The smaller the size of the aperture 21, the smaller the incident angle θ. In such arrangement, the incident angle θ ranges from 1 to 30 degrees. In a selectable embodiment, the incident angle θ ranges from 1 to 15 degrees. In a preferred embodiment, the incident angle θ ranges from 2.5 to 11.5 degrees. When considering 5 percent deviation, the incident angle θ ranges from 2.375 to 12.075 degrees. Moreover, FIG. 9 depicts that spectral resolution of spectrum is affected by the incident angle θ. As shown in FIG. 9, the bigger the incident angle θ (e.g. θ=10 deg), the lower the spectral resolution. The smaller the incident angle θ (e.g. θ=2.5 deg), the higher the spectral resolution. In sum, both the spectral resolution of spectrum and the energy of light can be determined by the size of the aperture 21. Therefore, the user can adjust the spectral resolution of spectrum and the energy of light to meet optimum condition for analyzing spectrum transmittance.

The size of the aperture 21 is tunable in the ninth embodiment. However, it is understood that the size of the aperture 21 can be fixed to meet a specific condition.

The aperture 21 is disposed on the receiving unit 15 in the ninth embodiment. However, it is understood that the aperture 21 can be disposed between the first optical element 13 and the receiving unit 15, between the object 20 and the first optical element 13, or between the second optical element 17 and the object 20.

As shown in FIG. 2, in the first embodiment, at least one aperture 21 is disposed on the receiving unit 15 (that is, a first position). However, it is understood that the aperture 21 can be disposed between the first optical element 13 and the receiving unit 15 (that is, a second position), between the object 20 and the first optical element 13 (that is, a third position), or between the light source 11 and the object 20 (that is, a fourth position). In brief, the aperture 21 can be disposed at the first position, the second position, the third position or the fourth position. Referring to Table 1, the size of the aperture 21 disposed at the first position, the size of the aperture 21 disposed at the second position, the size of the aperture 21 disposed at the third position and the size of the aperture 21 disposed at the fourth position are different for achieving same incident angle θ. It is worth noting that the size of the aperture 21 disposed at the third position is greater than the size of the aperture 21 disposed at the second position, the size of the aperture 21 disposed at the second position is greater than the size of the aperture 21 disposed at the first position, and the size of the aperture 21 disposed at the first position is greater than the size of the aperture 21 disposed at the fourth position. The description of the aperture 21 of the ninth embodiment (as shown in FIG. 8) is similar to those of the first embodiment described above, and therefore the descriptions thereof are omitted.

TABLE 1

| Size of the aperture disposed at different position (mm) | | | | |
|---|---|---|---|---|
| First | Second | Third | Fourth | Incident angle |
| position | position | position | position | (degrees) |
| 0.6 | 0.72 | 0.92 | 0.5 | 2.5 |
| 1.5 | 1.7 | 1.94 | 0.7 | 6 |
| 2.4 | 2.74 | 2.96 | 0.84 | 10 |
| 3 | 3.44 | 3.5 | 0.84 | 11.5 |

The optical detecting apparatus 10, 10′, 10″, 10′″, 10″″ of the invention can perform an accurate and stable measurement since the receiving unit applying MEMS processing techniques is used. Also, the structure of the optical detecting apparatus is simplified. Furthermore, by providing the optical element between the light source and the receiving unit for concentrating energy of light, the detection reliability of the optical detecting apparatus is increased.

What is claimed is:

1. An optical detecting apparatus, comprising:
a light source configured to emit first light;
a receiving unit comprising a light splitting portion and a sensing portion, wherein the light splitting portion is configured to separate second light with a predetermined bandwidth from the first light, the sensing portion is configured to receive the second light with the predetermined bandwidth, and the light splitting portion and the sensing portion are connected; and
a first optical element disposed between the light source and the receiving unit and configured to converge or collimate the first light.

2. The optical detecting apparatus as claimed in claim 1, wherein the light splitting portion is a Fabry-Perot interferometer produced by using MEMS (Microelectromechanial Systems) processing techniques;
wherein the light splitting portion and the sensing portion are connected to form a single element.

3. The optical detecting apparatus as claimed in claim 1, wherein the first optical element is disposed between an object and the receiving unit, the first light enters the object, part of the first light is absorbed by the object, and the other part of the first light leaves the object, is converged or collimated by the first optical element and arrives at the receiving unit.

4. The optical detecting apparatus as claimed in claim 3, wherein the first optical element is a lens or concave mirror.

5. The optical detecting apparatus as claimed in claim 3, wherein a ratio of a first distance from the light source to the first optical element to a second distance from the first optical element to the receiving unit ranges from 1 to 5.

6. The optical detecting apparatus as claimed in claim 3, further comprising a second optical element disposed between the light source and the object to converge or collimate the first light before the first light enters the object, and a ratio of a third distance from the light source to the second optical element to a second distance from the first optical element to the receiving unit ranges from 0.1 to 10.

7. The optical detecting apparatus as claimed in claim 6, wherein the second optical element is a lens or concave mirror.

8. The optical detecting apparatus as claimed in claim 6, further comprising an aperture disposed between the second optical element and the object, wherein size of the aperture is tunable or fixed, and an incident angle at which the first light is incident on the aperture ranges from 1 to 30 degrees.

9. The optical detecting apparatus as claimed in claim 6, further comprising an aperture disposed between the first optical element and the receiving unit or disposed on a surface of the receiving unit.

10. The optical detecting apparatus as claimed in claim 3, further comprising an aperture disposed between the object and the first optical element.

11. The optical detecting apparatus as claimed in claim 10, wherein size of the aperture is tunable or fixed, and an incident angle at which the first light is incident on the aperture ranges from 1 to 30 degrees.

12. The optical detecting apparatus as claimed in claim 3, further comprising an aperture disposed between the first optical element and the receiving unit or disposed on a surface of the receiving unit.

13. The optical detecting apparatus as claimed in claim 1, wherein the first optical element is disposed between the light source and an object; the first light is converged or collimated by the first optical element and enters the object; part of the first light is absorbed by the object; and the other part of the first light leaves the object and arrives at the receiving unit.

14. The optical detecting apparatus as claimed in claim 13, wherein a ratio of a first distance from the light source to the first optical element to a second distance from the first optical element to the receiving unit ranges from 0.2 to 5.

15. The optical detecting apparatus as claimed in claim 13, wherein the first optical element is a lens or concave mirror.

16. The optical detecting apparatus as claimed in claim 13, further comprising an aperture disposed between the object and the first optical element, wherein size of the aperture is tunable or fixed.

17. The optical detecting apparatus as claimed in claim 1, wherein the first optical element is a lens or concave mirror.

18. The optical detecting apparatus as claimed in claim 1, wherein the light splitting portion is an adjustable light filter or a light splitter.

19. The optical detecting apparatus as claimed in claim 1, further comprising an aperture disposed between the light source and the receiving unit or disposed on a surface of the receiving unit.

20. The optical detecting apparatus as claimed in claim 19, wherein an incident angle at which the first light is incident on the aperture ranges from 1 to 30 degrees.
